(19) United States
(12) Patent Application Publication
(10) Pub. No.: US 2004/0183896 A1
(43) Pub. Date: Sep. 23, 2004

(54) Cooperative application system, cooperative application method, and network terminal

(75) Inventors: Kouichi Takamine, Hyogo (JP); Atsushi Hirose, Berkshire (GB)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD

(21) Appl. No.: 10/768,086

(22) Filed: Feb. 2, 2004

(30) Foreign Application Priority Data
Feb. 5, 2003 (JP) 2003-028034

(51) Int. Cl. H04N 7/14

(52) U.S. Cl. 348/14.08

(57) ABSTRACT

This invention provides a cooperative application system that is capable of displaying and reproducing the video or audio of a presentation at various locations that are separated from the location of the presentation without breaking up, and is also capable of reducing the burden of operation processing inside the terminal, and the terminal on the sending side comprises: a first application-control unit that outputs instructions to the application operating at the sending terminal; and a sending unit that sends the instructions that were output from the first application-control unit to the receiving terminal; and on the terminal on the receiving side comprises: a receiving unit that receives the instructions from the terminal on the sending side; and a second application-control unit that outputs the received instructions to the application operating at the terminal on the receiving side.

### BACKGROUND OF THE INVENTION

1. Field of the Invention

This invention provides a cooperative application system and network terminal that links the operation of applications used by presenters at a multimedia conference with the applications of the participants at the conference.

2. Description of the Related Art

Currently, various kinds of communication services are provided by different communications businesses to general consumers and business users. One of these services is a audio conference server that connects normal telephones, portable telephones, PHS phones and the like that are located at different locations and allows simultaneous conversation (for example a chorus line service).

On the other hand, with the increasing size of the Internet market, text-conference services and text-chat services are also provided that allow users to share data-type information such as text data, image data and music data over the Web with many users (for example, a Web conference room).

In network-provided conference services such as the audio-conference services or text-conference services described above, it is desired that real-time audio-conference services and data-type services be mutually linked together based on user needs and diversification of the type of business.

Moreover, in recent years, due to the advancement of VOIP (Voice over IP), Internet telephone applications that make two-way, real-time audio communication possible over an IP (Internet protocol) packet network such as the Internet are beginning to become popular.

A prior system that provides a multimedia conference service that links the operation of data-type conferencing and real-time audio conferencing comprising at least an image-information-sharing unit, white-board-sharing unit, speaker-screen-display unit, arbitrary-information-searchunit, arbitrary-information-noticeunit, or conference-minutes-creation unit has been made possible. Also, for audio conferencing, multimedia-conferencing services are provided that combine a audio-communication terminal for circuit switching, such as a telephone terminal, and a VOIP communication terminal, such as an Internet-telephone terminal (for example, refer to Japanese unexamined patent publication No. 2001-292138 (paragraphs 1 to 7, and FIG. 2)).

Typically, in the case of performing communication using a shared transmission media type of network, the amount of information that can be transmitted by a terminal at a certain time varies according to the amount of information that is transmitted by another terminal during that time. Therefore, when a terminal is attempting to transmit data, it is not possible to guarantee that all will be transmitted without delay. Actually, in the case in which the output video of the application that is displayed on the terminal on the presenter's side is transmitted together with the video and audio of the presenter, the amount of data to be transmitted becomes very large so problems may occur such as audio data not matching the video data, or delays in transmitting data due to an increase in the amount of traffic. In other words, on the receiving side, when there is a delay in the display of the image with respect to the audio, or when the image is broken up, or when it is clearly evident that the audio (conversation) of the presenter is delayed, it becomes difficult to maintain a conversation.

Particularly, in the prior technology, video of the documents presented by a plurality of users located at different locations was provided by transmitting the video presented by the user of the terminal at the transmission source to a plurality of terminals on the receiving sides that were connected over the network. Also, at the same time as this, the video of the presenter, for example, was transmitted as a moving image. Therefore, there was a problem in that each time the video of the documents being presented changed, the video of the documents being presented had to be sent to the receiving side, and whenever the video of the documents being presented changed, the video of the presenter and documents was broken up due to the increase in traffic. In order to deal with this problem, the next generation Internet protocol IPv6 (Internet Protocol Version 6) is being installed. This new version IPv6 is based on the current IPv4 (Internet Protocol Version 4), and is improved by having an increased amount of address space, added security features, and data transmission according to priority, and it makes it possible to perform control such that AV packet information from network cameras (or digital cameras) is sent or received having priority.

However, particularly in the case of providing the multimedia-conference service described above, it is necessary that both the computer, which is used near the screen that uses text, and the home television, on which moving images are watched away from the screen, have adequate resolution, and a resolution of 2 M-pixels/frame is necessary. This corresponds to the HDTV 1100 that is shown in FIG. 11, or in other words, corresponds to high-definition (HD) quality. From now on, this kind of high-definition quality will become the norm, and when it further becomes possible to frequently send and receive a plurality of AV information, naturally the amount of traffic on the network will increase. Therefore, it may not be possible to completely solve the problems related to the amount of network traffic even when using the IPv6 that gives priority to sending AV information.

Furthermore, there are also problems in processing the data on the receiving side. That is, when switching videos at the terminal on the sending side, processing is performed by the terminal on the receiving side to switch the video from the video before the change to the video after the change, so the amount of internal processing performed by the terminal on the receiving side increases, and a problem exists in that the sound ceases because sequential processing of the sound by the VOIP becomes impossible. From this aspect as well, it is predicted that this will become an even larger problem due to the increase in the amount data for changing to high definition quality.

It is the object of this invention to provide a cooperative application system and network terminal that is capable of displaying and reproducing the video and audio of a presentation at a location that is separated from the location of the presentation without a break up in the video or sound, and further is capable of reducing the load of internal operation processing of the terminal.

### SUMMARY OF THE INVENTION

In order to accomplish the aforementioned object, this invention adopts the following means. That is, it is presumed in this invention that the cooperative application system links the operation between a terminal on the sending side with a terminal on the receiving side that is connected by way of a network. Here, the terminal on the sending side comprises: a first application-control unit that outputs instructions to the application operating at the terminal on the sending side, and a sending unit that sends the instructions that were output from the first application-control unit to the terminal on the receiving side. In other words, the first application-control unit sends instructions to the application that is operating at the terminal in which it itself is mounted, and the sending unit also sends that instruction to the terminal on the receiving side. Moreover, the terminal on the receiving side comprises: a receiving unit that receives the instructions from the terminal on the sending side; and a second application-control unit that outputs the received instructions to the application that is operating at the terminal on the receiving side.

By doing this, it is possible to link to and display the presented documents at the terminal on the receiving side without sending the video data of the presented documents that are output by the application of the terminal on the sending side, so it is possible to reduce the amount of traffic on the network and to lighten the burden of the operation processing by the terminal on the receiving side, and further it is possible to output the video and audio of the presenter together with the video of the presented documents that are output by the application to a multiple of locations that are separated from the location of the presentation.

Also, at least either the terminal on the sending side or the terminal on the receiving side comprises an application-data-management unit that checks the compatibility between itself and at least the type of application that is operating at another terminal, the application status at another terminal, or the application data that is used by the application at another terminal.

With this construction, it is possible to avoid trouble such as when the linked operation of applications become strange when the application data used by the application on the side of the presenter differs from the application data used by the application of another participant of the conference.

Also, the sending unit sends address information for the terminal on the receiving side, contents to be used by the application that is operating at the terminal on the receiving side, and sending instructions to a specified server for sending the contents to the terminal on the receiving side; and the receiving unit receives those contents from the server and gives them to the application that is operating at the terminal on the receiving side.

Furthermore, the sending unit sends the contents that are to be used by the application operating at the terminal on the receiving side to a specified server, and sends the address information of that server to the receiving unit of the terminal on the receiving side; and the receiving unit receives those contents from the server according to the received address information for the server, and gives the contents to the application that is operating in the terminal on the receiving side.

By doing this, the terminal on the sending side is able to send the contents for a conference or the like to a server at an appropriate time before the contents become necessary, or in the case in which the contents to be used are already stored in the server, it is able to obtain those contents at an appropriate time according to conditions at each location.

Also, the terminal on the receiving side comprises a first time-control unit that synchronizes the video signal that was input to the video-input unit, the audio signal that was input to the audio-input unit, and the instructions that were output from the application-control unit and outputs them to the sending unit; and the terminal on the receiving side comprises a second time-control unit that receives the synchronized video signal, audio signal and instructions, and synchronizes and output the video, audio and instructions.

With this construction, by performing synchronization, it is possible to lessen the problem of delays in transmitting data due to shifts in audio data and video data or increases in the amount of traffic.

When the video signal that is input from the video-input unit is a high-definition video signal, the amount of data that the video occupies becomes large, and further, since a large amount of processing by the terminal on the receiving side becomes necessary, the effect of this invention is very evident.

Here, the cooperative application system and network terminal can be embodied using a computer. In that case, each of the units described above are embodied by operating a program on a computer.

With the cooperative application system, cooperative application method and network terminal of this invention, copy data of the documents presented by the user on the sending-terminal side is also set at the receiving-terminal side, and by operating the application, the video signal that is output from the application at each of the locations is switched according to an application-output-switch instruction from the user of the sending terminal or preset conditions. As a result, it is effective in reducing the amount of network traffic, lightening the load due to operation processing by the terminal on the receiving side, and outputting video and audio of the presenter together with the application-output video of the presented documents without breaking up.

### BRIEF DESCRIPTION OF THE DRAWINGS

FIG. 1 is a schematic diagram for explaining the cooperative application system of a first embodiment of the invention.

FIG. 2 is a block diagram showing the construction of the cooperative application system of the first embodiment of the invention.

FIG. 3 is a drawing showing the flow of the processing by the cooperative application system of the first embodiment of the invention.

FIG. 4 is a block diagram showing the internal construction of the application-control unit of the first embodiment of the invention.

FIG. 5 is a schematic drawing for explaining the cooperative application system of a second embodiment of the invention.

FIG. 6 is a block diagram showing the construction of the cooperative application system of the second embodiment of the invention.

FIG. 7 is a drawing showing the flow of the processing by the cooperative application system of the second embodiment of the invention.

FIG. 8 is a block diagram showing the construction of the cooperative application system of a third embodiment of the invention.

FIG. 9 is a block diagram of the time-control unit of the third embodiment of the invention.

FIG. 10 is a timing chart for the video signal, audio signal, application-control signal and synchronization-signal of the cooperative application system.

FIG. 11 is a drawing showing the amount of operations and the transmission speed required for encoding and decoding digital video.

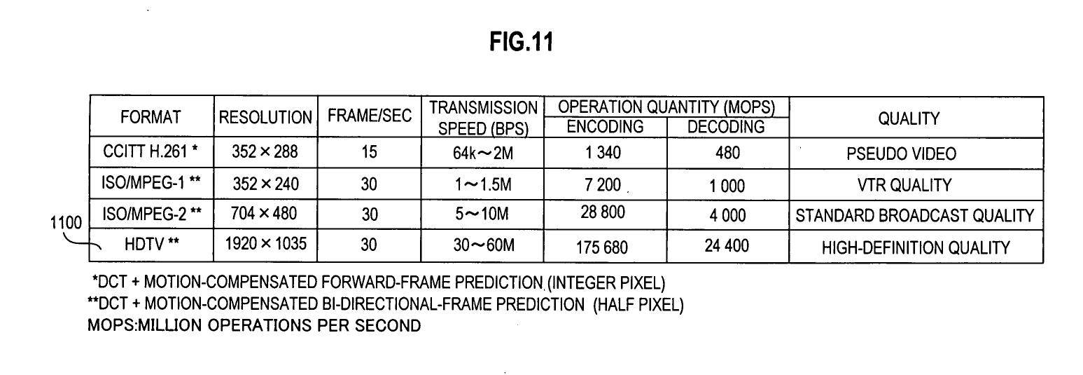

### DESCRIPTION OF THE PREFERRED EMBODIMENTS

The preferred embodiments of the invention will be explained in detail below using the drawings.

### Embodiment 1

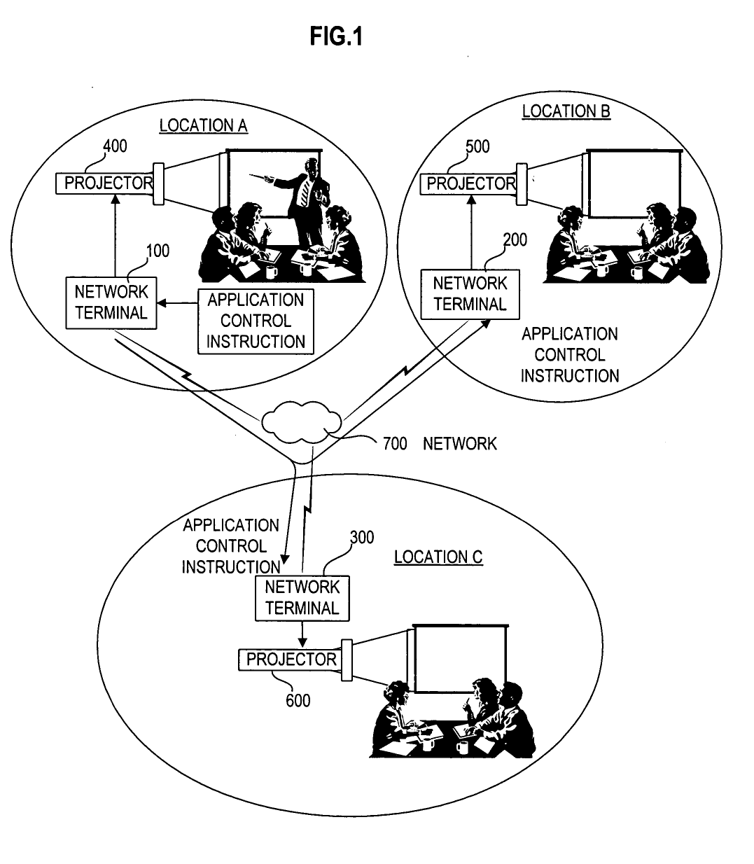

FIG. 1 is a schematic drawing for explaining the cooperative application system in a multimedia-conferencing system that uses the network terminals of this invention.

The network terminals 100, 200, 300 are used as user terminals in the multimedia-conference system. Also, network terminal 100 is the terminal used by the presenter and is located on the side of the presenter, and network terminals 200, 300 are located at the locations of the participants who participate in the conference. Hereafter, when the terminals are simply referred to as the participants, it will be assumed that the presenter is not included.

The network terminals 100, 200, 300 at each location are respectively connected to projectors 400, 500, 600 that receive video signals that are output from the network terminal, and project the received video on respective screens 800, 900, 1000.

In this invention, the network terminal 100 on the presenter's side outputs the application data of the presentation documents as a video signal to the projector 400, and switches between video signals to be output to the projector according to instructions from the presenter or according to a preset condition. The presenter instructions referred to here are instructions from the user that is actually using the video projected on the projector to the application that is outputting the presentation documents to switch screens. Also, the preset condition referred to here is switching timing that is set for the application that outputs the presentation documents, and it is preset for the application by the user to automatically switch the output video.

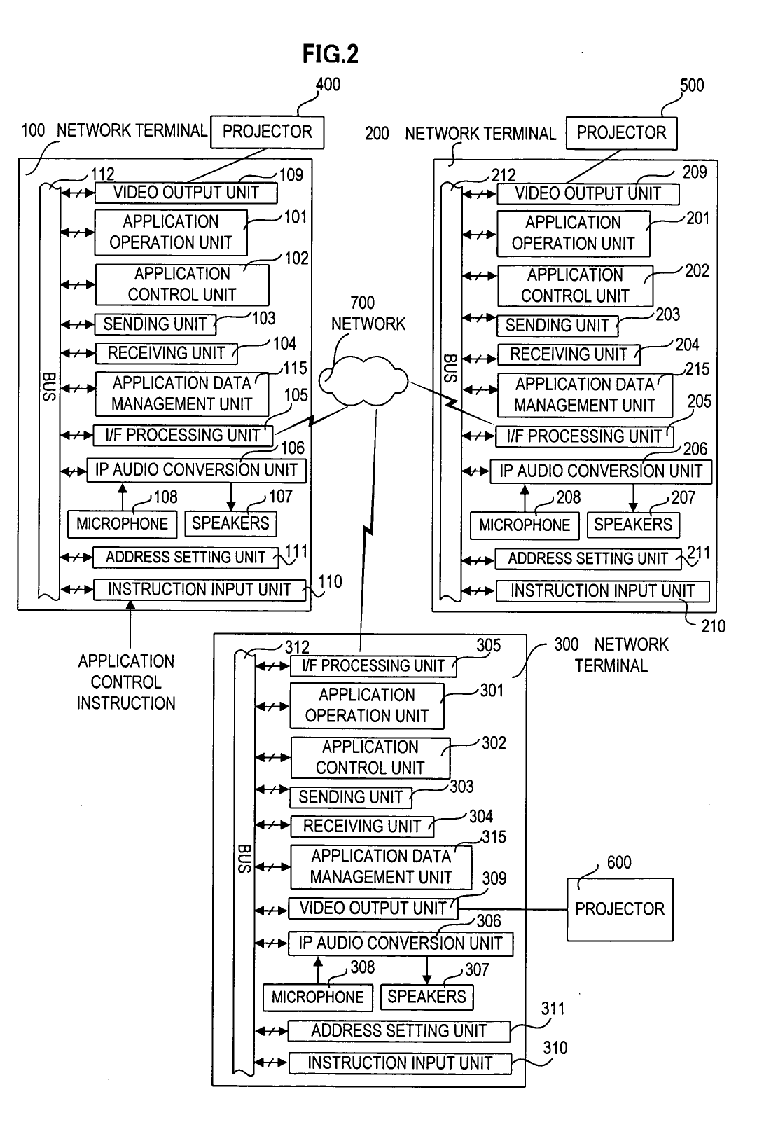

The network terminals will be explained here using FIG. 2. FIG. 2 is a block diagram showing the construction of the cooperative application system.

In FIG. 2, the network terminal 100 can be embodied by connecting it to the units described below by way of a bus 112.

The application-operation unit 101 reads the presentation documents used in the conference and converts them to video data, and operates the application.

The instruction-input unit 110 is a unit that allows the user to input instructions to the terminal such as an instruction to switch the video that the application outputs, and it corresponds to the mouse or keyboard.

The application-control unit 102 outputs instructions to the application to perform specified operations according to instructions input by the user from the instruction-input unit 110 or according to a preset condition.

When the instruction that is output from the application-control unit 102 is sent from the network terminal, the sending unit 103 sends it to a network terminal that is used by another user (for example, network terminals 200, 300).

When the user of another network terminal (for example, network terminal 200, 300) sends an instruction to an application that is operated by another network terminal, the receiving unit 104 receives that instruction.

The I/F processing unit 105 connects to the network in order to perform communication with the peripheral devices of the network terminal 100.

The IP-audio-conversion unit 106 performs conversion of IP packet signals and audio signals for sending audio in both directions in real-time over an IP packet network such as the Internet.

The speakers 107 output the audio signal that was converted by the IP-audio-conversion unit 106. Also, the microphone 108 inputs audio to the IP-audio-conversion unit 106 as an audio signal.

The video-output unit 109 outputs the video signal that is output from the application that is being operated by the application-operation unit 101 to the display unit that is connected to the network terminal 100.

The address-setting unit 111 receives input for the address of the terminal and the address of the destination terminals, and stores the input addresses.

The application-data-management unit 115 checks the version and status of the applications operating at each terminal, the compatibility of the read application data, and like.

The network terminals 200, 300 are network terminals having the same functions as the network terminal 100. Reference numbers 201 to 211 of network terminal 200, or numbers 301 to 311 of network terminal 300 correspond to the numbers 101 to 111 of network terminal 100, and since the operation is the same, an explanation will be omitted here.

The projectors 400, 500, 600 are connected to the network terminals 100, 200, 300, respectively, and they receive the video signal from the video-signal-output units 109, 209, 309 and project the video on the screens (not shown in FIG. 2). In other words, they function as the display units.

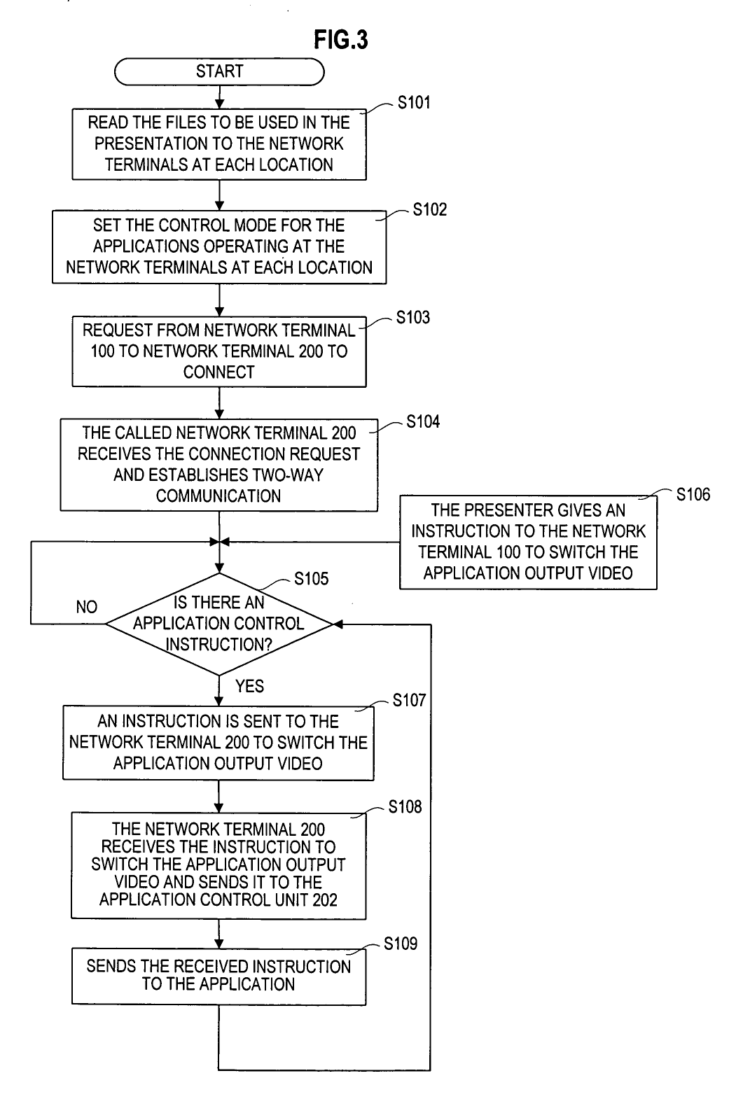

Next, the operation of the cooperative application system will be explained using FIG. 1, FIG. 2 and FIG. 3. FIG. 3 is a flowchart showing the flow of processing by the cooperative application system.

Here, as shown in FIG. 1 and FIG. 2, network terminal 100 is set up at location A, network terminal 200 is set up at location B and network terminal 300 is set up at location C. Network terminal 100 at location A, network terminal 200 at location B and network terminal 300 at location C are connected such that they can communicate with each other over network 700. Also, when one of the network terminals calls another, and the user of the network terminal that receives the call responds to the call, two-way audio communication becomes possible. In order to simplify the explanation below, a conference between two location, location A and location B, will be explained.

First, the application operated by the application-operation unit 101 of network terminal 100 reads application data as the presentation material used in the presentation. Also, the application-control unit 102 sends an instruction to the application based on an instruction from the user or based on a preset condition, and as a result the application switches the video signal to be output to the projector 400.

Also, electronic files, which are presentation documents, are sent from the user to the participants in the conference in advance, and the participant at each of the locations (for example, location B) reads the electronic files that were received in advance into the application of the network terminal 200, and the same condition as the presenter, or in other words, the standby state is set (FIG. 3: step S101). The applications used at location A and location B are the same.

At this time, the application-data-management units 115, 215, 315 of each of the network terminals can be such that they check the communications as to whether or not there are any differences in the electronic files that set the status to standby and that are used in the conference. For example, the application-data-management unit 213 makes an inquiry of the application-data-management unit 113 to check whether or not information related to the presentation documents, such as the file names and dates of creation of the files used in the conference, is the same. By doing this, it is possible to avoid problems such as differences in the presentation documents activated by the application on the side of the presenter and the presentation documents activated by the application on the side of the participant, and abnormal operation of the cooperative application system. Moreover, at the same time, the application-data-management unit can check whether or not the applications used and versions of those applications are the same, or whether or not the status of the applications is the same. The status referred to here is whether the application is in the input-ready state (whether there is focus), and whether the display size of the application is within a specified range. By performing this check, it is possible to assure proper operation of the cooperative application system.

Next, the control modes of the network terminals used at each location are set. For example, the network terminal 100 that is used at location A on the side of the presenter is set to the mode to receive instructions (application-control signals) from the instruction-input unit (normal control mode). The network terminal 200 that is used by another participant in the conference (for example, at location B) is set to the mode to receive instructions from the outside by way of the receiving unit (remote-control mode) (FIG. 3: step S102). These settings are performed using a control-mode signal from the instruction-input unit.

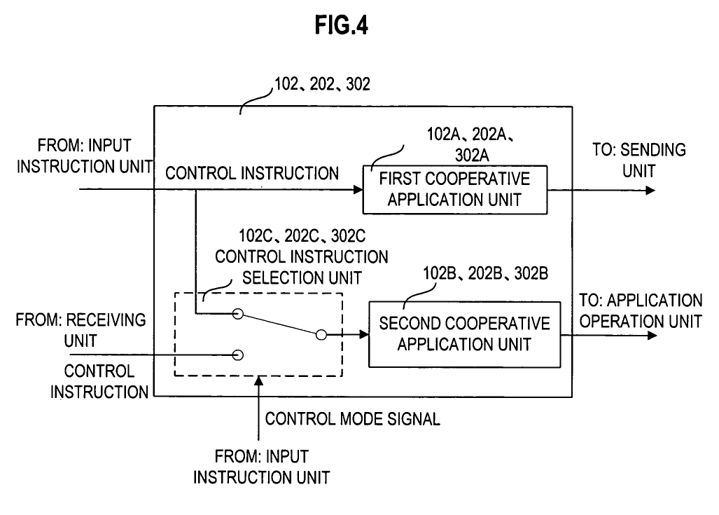

Here, FIG. 2 and FIG. 4 will be used to explain the differences in the operations of the application-control units 102, 202, 302 according to the control mode. FIG. 4 is a block diagram showing the internal construction of the application-control unit.

The first cooperative application unit 102A receives an instruction from the instruction-input unit 110 in order to link operation with the external application of network terminal 100, and sends it to the sending unit 103.

Also, the control-instruction-selection unit 102C selectively outputs the instruction from the instruction-input unit 110 or instruction received by the receiving unit 104 based on the preset control mode. In other words, when the control mode is set to the normal control mode, the instruction input from the instruction-input unit is output to the application-operation unit, on in other words the application, and when the control mode is set to the remote-control mode, the instruction received by the receiving unit is output to the application.

The second cooperative application unit 102B sends the instruction received from the control-instruction-selection unit 102C to the application operated by the application-operation unit.

Units 202A, 202B, 202C of network terminal 200, or units 302A, 302B, 302C of network terminal 300 correspond to units 102A, 102B, 102C of network terminal 100 and the operation is the same. Therefore, an explanation of units 202A, 202B, 202C, and units 302A, 302B, 302C will be omitted here.

The flow of the processing by each unit is described below.

The network terminals 100, 200 comprise address-setting units 111, 211, and by setting the address of the main unit, it becomes possible to perform two-way communication by simply connecting to the network. In other words, the user of network terminal 100 at location A specifies the communication destination (here this is the network terminal 200 at location B), and connects to that terminal by way of the network. On the other hand, when the connection destination receives that connection request, two-way communication becomes possible (FIG. 3: step S103 to step S104).

In the state where two-way communication becomes possible, it is possible for the user at location A to perform audio communication with the user at the other location (for example, location B). Also, in this state, the network terminal is in the standby state waiting for a control instruction for the application (FIG. 3: step S105).

The presenter sends an instruction to the network terminal 100 from the instruction-input unit 110 to switch the application output video (or, sets in advance the switching timing for the application, and sends an instruction to switch the application output video based on that switch-timing setting) (FIG. 3: step S106). The main instruction needed for the application at the conference locations is for changing the video that the application outputs, however, switching the application output video referred to here includes all of the instructions for the application. In other words, the same occurs even when instructions other than the instruction to switch the output video are sent to the application. In other words, the output video from the application is not included in the instruction.

When the application-control unit 102 of the network terminal 100 receives an instruction from the presenter, it sends that instruction to the application-operation unit 101. Also, the application-control unit 102 sends the instruction by way of the sending unit 103 to the network terminal 200 used by another participant in the conference (for example, at location B) (FIG. 3: step S107).

The network terminal 200 receives the instruction that was sent from the network terminal 100 on the side of the presenter by way of the receiving unit 204, and then sends it to the application-control unit 202 of the network terminal 200 (FIG. 3: step S108).

The application-control unit 202 sends a control instruction to the application to switch the output video received from the other application (FIG. 3: S109). In this way, the video output from the application on the side of the network terminal 200 is switched according to the instruction from the network terminal 100 at location A, and as a result, it is possible to switch the video output from the application at location B together with switching of the video output by the application at location A.

As explained above, with this invention, a copy of the data of the presentation documents presented by the user of the network terminal on the side of the presenter is also set in the network terminal on the receiving side and the application is operated, and the video signal that is output from the application at other locations is switched according to an instruction from the user of the sending network terminal to switch the output from the application, so it is not necessary to send a large quantity of data to the receiving side. As a result, it is possible to reproduce the same video as the presented video at a location separated from the location of the presentation without the video breaking up and without delays. Also, the data received for the video is just an instruction to the application, so it is possible to lighten the burden of operation processing inside the terminal. Naturally, the applications at each location, the status of the application and compatibility of the application data are ensured by communication between application-data-management units.

The audio signal during the conference is obtained by the network terminal from the microphone 108 (208, 308) of the network terminal at each location, and the IP audio-conversion unit 106 (206, 306) converts it from an audio signal to audio IP packet data. Here, sending audio will be explained using the audio signal obtained by the microphone 108 of the network terminal 100 that is sent to the network terminals 200, 300 at other locations as an example. The audio IP packet data that was converted by the IP audio-conversion unit 106 of the network terminal 100 is sent to the other network terminals (for example, network terminal 200, 300) participating in the conference other than the network terminal (for example, network terminal 100) that sends the audio IP packet data from the sending unit 103 via the network 700. The network terminals (for example, network terminals 200, 300) that receive audio packet data, receive the audio packet data by way of the receiving unit (for example, 204, 304). The audio packet data that is received by the receiving unit is converted to an audio signal by the IP audio conversion unit (for example, 206, 306), and reproduced by the speakers (for example, 207, 307). Also, in the case where the receiving unit of one network terminal 200 received a plurality of audio packet data, the audio packet data is converted by the IP audio-conversion unit 206 into an audio signal, and then a combining process can be performed. By doing this, it is possible to reproduce in real-time the audios of a plurality of conference participants. In addition, since switching the application data is possible by simply sending and receiving display switching instructions as described above instead of sending display data as done conventionally, multimedia conferencing that is more efficient and economical than conventional real-time telephone conferencing is possible.

Moreover, in the explanation above, an example of switching the application output video was used for explaining the operation of linking the application on the side of network terminal 100 with the application on the side of the network terminal 200, and switching the output video, however, this invention is not limited to this, and it is also possible to link other operations by sending and receiving instructions for similarly controlling the operations of network terminals at different locations.

### Embodiment 2

In a second embodiment of the invention, a cooperative application system is explained in which contents are stored on an Internet server, and when the contents are necessary, a request is sent from a terminal to the server to send the contents.

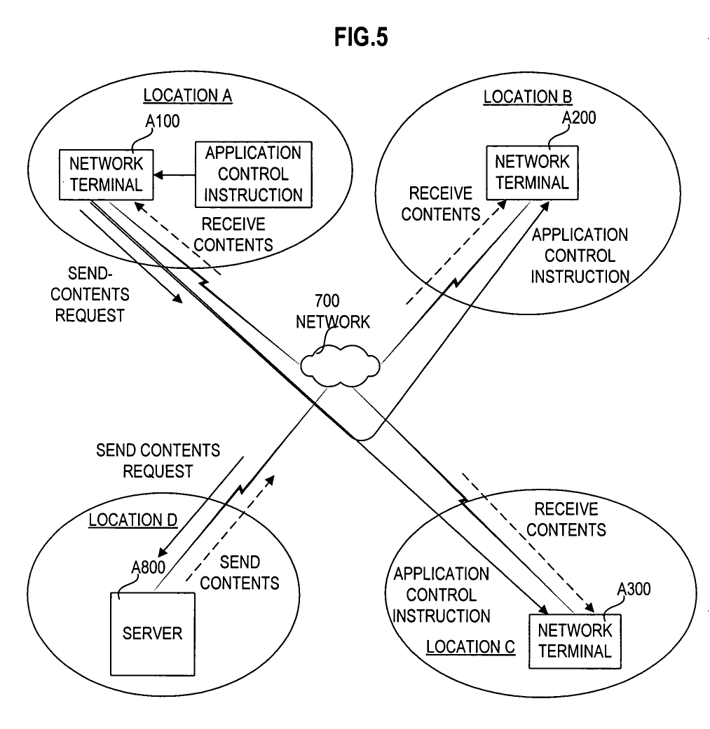

FIG. 5 is a drawing for explaining the cooperative application system of this second embodiment of the invention.

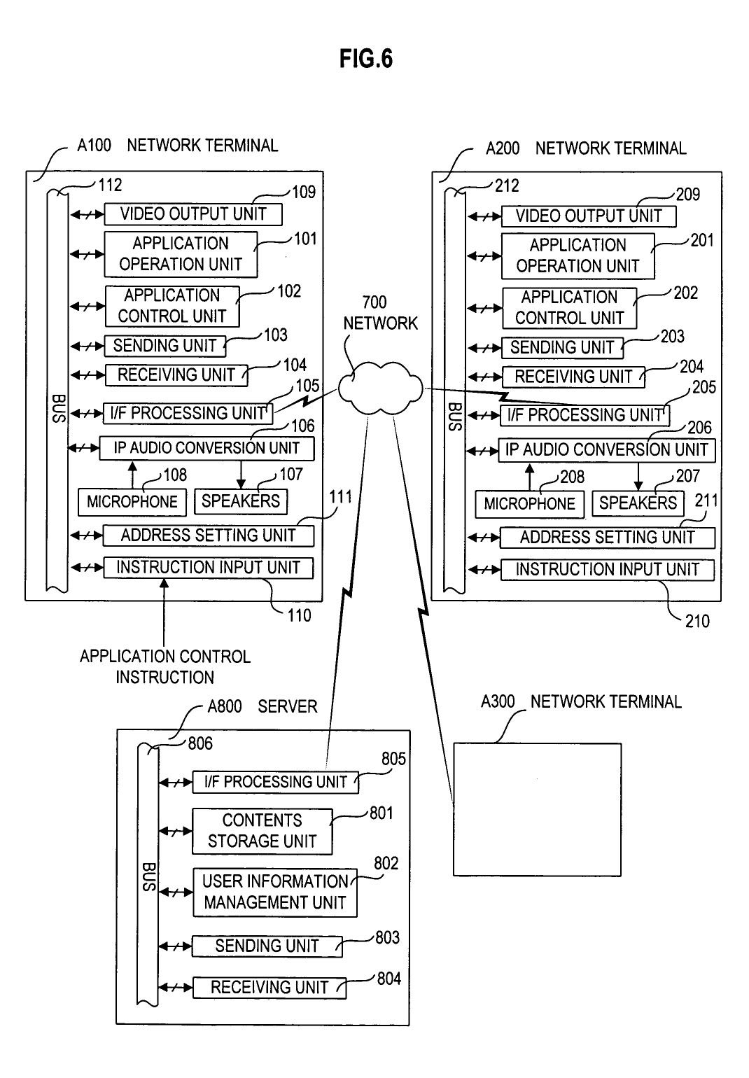

Also, FIG. 6 is a block diagram shown the construction of the cooperative application system of this second embodiment of the invention.

Network terminals A100, A200, A300 are network terminals on the side of the users of a multimedia conference system. Also, network terminal A100 is located on the side of the presenter, and network terminals A200, A300 are located at each conference location. Moreover, each of the network terminals A100, A200, A300 have the same construction and same functions as the network terminals 100, 200, 300 in the first embodiment, and so any redundant explanation of them will be omitted here.

The server A800 receives a send-contents request from a network terminal and sends the contents to each network terminal, and this is made possible by connecting each of the units described below via a bus 806. The server A800 as shown in FIG. 6 has only the elements necessary for this second embodiment.

The contents-storage unit 801 stores contents that were received from the outside via the network 700 or a portable recording medium.

The user-information-management unit 802 manages the users that send contents such as conference documents to the server, and users that receive contents from the server.

The receiving unit 804 receives contents from an external network terminal, or receives instructions to distribute received contents to a specified external network terminal.

The sending unit 803 sends contents to a specified external network terminal based on a contents-distribution instruction received by the receiving unit 804.

The I/F processing unit 805 performs the connection process for connecting to the network in order to communicate with devices outside of the server A800.

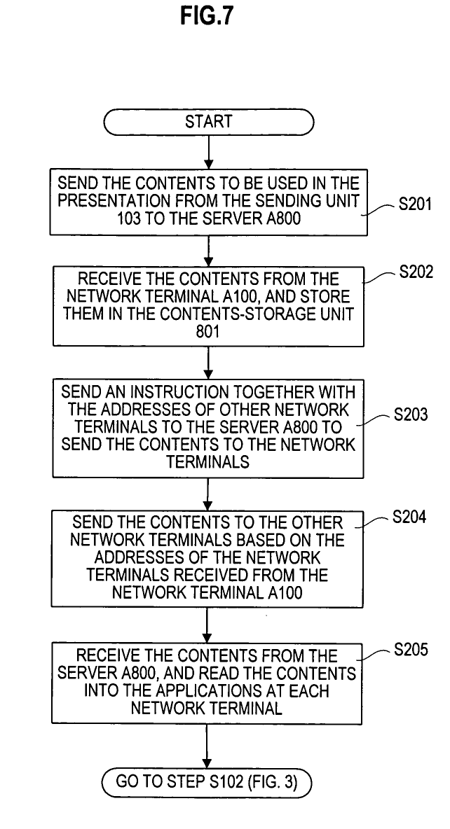

Next, FIG. 5, FIG. 6 and FIG. 7 will be used to explain the operation of the cooperative application system of this second embodiment. FIG. 7 is a flowchart showing the flow of processing performed by the cooperative application system of this second embodiment. The processes that differ from those of the first embodiment will be explained here. As in the first embodiment and as shown in FIG. 5 and FIG. 6, the network terminal A100 is located at location A, network terminal A200 is located at location B, and network terminal A300 is located at location C. The network terminal A100 at location A, the network terminal A200 at location B, and the network terminal A300 at location C are connected over a network 700 such that they can communicate with each other. In order to simplify the explanation below, an example of a conference between the two locations, location A and location B, will be explained.

The application being operated by the application-operation unit 101 of the network terminal A100 reads the documents used in the presentation beforehand. Also, the application-control unit 102 sends instructions that are output to the application based on an instruction from the presenter, or based on a preset condition. As a result, the application switches the video that is output to the projector (not shown in the figure). Also, the sending unit 103 of the network terminal A100 sends the contents to be used in the presentation to the server A800 (FIG. 7: step S201).

Next, the server A800 receives the contents from the network terminal A100 via the network 700, I/F processing unit 805 and receiving unit 804, and stores the contents in the contents-storage unit 801 (FIG. 7: step S202).

The method of receiving the contents is not limited to receiving contents from the network terminal via the network, for example, it is also possible to receive the contents via a portable medium. Also, the contents are not limited to being the presenter's documents on the side of network terminal A100, for example, the contents could also be documents that were created by some means other than by the network terminals A100, A200, A300. Needless to say, in this case, it is necessary for the rights to use the documents by the network terminals be given for contents that were created by other than the network terminals.

Also, after the network terminal A100 calls another terminal A200 and two-way communication becomes possible, a send instruction to send the contents to the other terminal is sent together with the address information of the other terminal to the server A800 (FIG. 7: step S203).

The server A800 sends the contents to the other terminal based on the address information of the other terminal that was received from the network terminal A100 (FIG. 7: step S204).

The network terminals receive the contents from the server A800, and the applications of each of the network terminals read the contents (FIG. 7: step S205).

After the contents, or in other words, after the application data to be used in the presentation has been read by the network terminals at each location, the mode of the applications operated by the network terminals at each location is set (FIG. 3: step S102).

The following processing is executed the same as in embodiment 1 (FIG. 3: steps S103 to S109).

With the cooperative application system and cooperative application method of the second embodiment described above, before the terminal on the receiving unit uses the contents, the contents are sent from the terminal on the sending side to a server, and the terminal on the receiving side receives the contents from the terminal on the sending side via the server. Therefore, the terminal on the sending side can send the contents to the server at a suitable time before the contents are needed at the conference or the like.

In the second embodiment described above, an example was explained in which after the network terminal A100 calls another terminal A200 and two-way communication becomes possible, the network terminal A100 sends a send instruction together with the address of the other terminal to the server A800 in order to send contents to the other terminal, however, the timing for each of the network terminals to receive the contents from the server A800 is not limited to this, and it can be set as desired as long as the operation of the applications at each location can be linked together before the presenter on the side of network terminal A100 uses the contents in a presentation.

For example, the contents and the address of the network terminal at the distribution destination are sent beforehand from the network terminal A100 to the server A800, and the server A800 stores the contents in the contents-storage unit 801, and registers the address of the network terminal at the distribution destination in the user-management unit. Also, the network terminal A100 sends contents-acquisition information (here, this is address information for the server A800) to the other terminal. After the other network terminal A200 connects to the network 700, it sends a send-contents request to the server A800. The server A800 receives the send-contents request from the other network terminal A200 and sends the user address from the user-information-management unit and the corresponding contents.

By doing this, after each network terminal connects to the network 700 and is in a state capable of communication, each network terminal can receive the contents by sending a send-contents request to the server A800, so anytime after the contents to be used are stored in the server A800, it is possible to receive the contents at a time suitable to the conditions at each location.

Also, in the second embodiment described above, the case in which the network terminals A100, A200, A300 have the same construction and function as the network terminals 100, 200, 300 of the first embodiment was explained, however, the terminals do not have to be a special terminal for conferencing such as a network terminal, and any terminal that is constructed such that is can achieve the functions described above, such as a personal computer, could be used.

### Embodiment 3

In the third embodiment of the invention, a cooperative application system that synchronizes the video, audio and application control is explained.

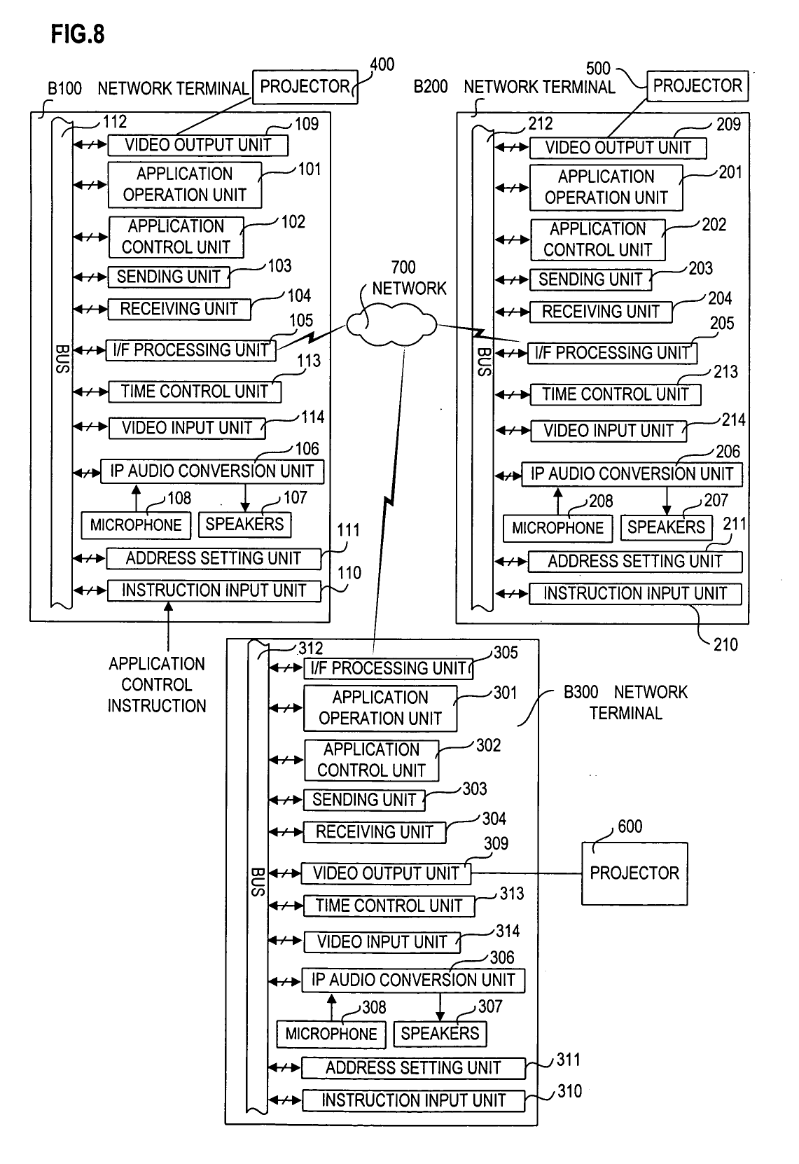

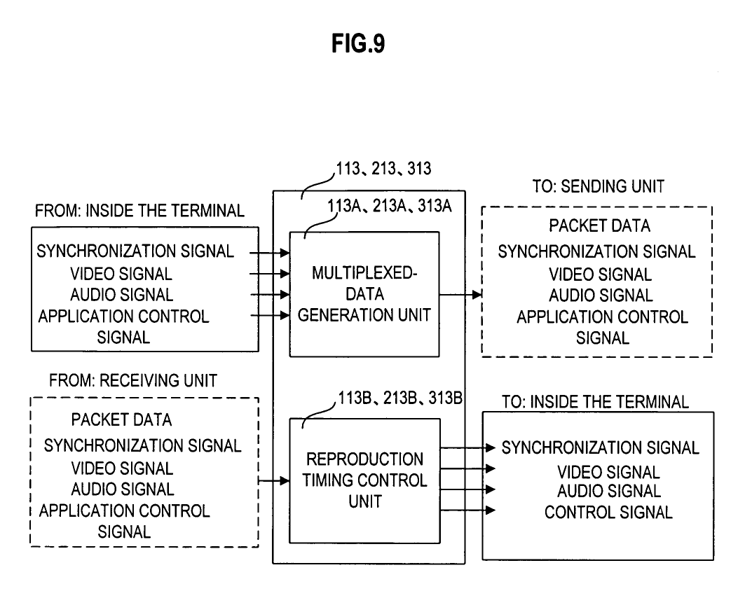

FIG. 8 is a block diagram of the cooperative application system of this third embodiment of the invention. Also, FIG. 9 is a block diagram of the time-control unit of this third embodiment of the invention.

Network terminal B100 is located on the side of the presenter, and network terminals B200 and B300 are located at each of the conference locations. Also, each of the network terminals B100, B200, B300 have the same functions as the network terminals 100, 200, 300 in the first embodiment, with only the time-control units 113, 213, 313 being added to the terminals. Here, any redundant explanation of the functions that are the same as those already explained for the first embodiment will be omitted.

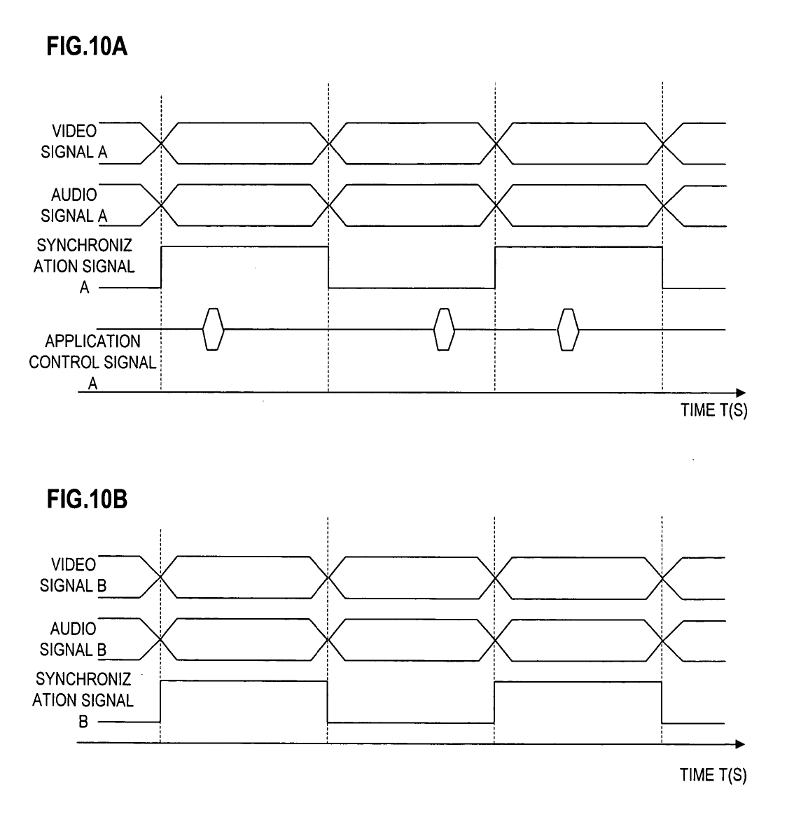

Here, FIG., 8, FIG. 9 and FIG. 10 will be used to explain the processing by the time-control units.

The time-control units 113, 213, 313 that are shown in FIG. 8 and FIG. 9 comprise: a multiplexed-data-generation unit 113A (213A, 313A), and a reproduction-timing-control unit 113B (213B, 313B). The multiplexed-data-generation unit 113A (213A, 313A) generates multiplexed packet data that synchronizes the video signal, audio signal and application-control signal with a specified synchronization signal. The application-control signal is a signal that transmits instructions to the application. Also, the reproduction-timing-control unit 113B (213B, 313B) divides up the packet data received from a terminal on the sending side into a video signal, audio signal and application-control signal, and performs control such that the video, audio and application control are synchronized.

Here, the synchronization signal is handled as one channel, however, as in the bit-multiplexing method, when generating multiplexed data, it is possible to embed the synchronization signal for indicating the frame divisions in a fixed period, and then detect this synchronization signal on the receiving side and identify which media of the video signal, audio signal and application-control signal the synchronization signal and bits correspond to, and perform synchronization.

The video-input units 114, 214, 314 shown in FIG. 8 input video to the terminal from a digital camera or network camera (not shown in the figure) that is located on the side of the terminal.

When a terminal operates as a terminal on the sending side, the multiplexed-data-generation unit 113A, 213A, 313A shown in FIG. 9 generates packet data from the multiplexed video signal from the video-input unit 114, audio signal form the microphone 108 and application-control signal that is output from the application-control unit 102, and sends it to the sending unit 103, 203, 303.

When a terminal operates as a terminal on the receiving side, the reproduction-timing-control unit 113B, 213B, 313B separates the packet data received by the receiving unit 104, 204, 304 into a video signal, audio signal, application-control signal and synchronization signal, and reproduces and outputs the synchronized video, audio and application data.

FIGS. 10 shows the timing of the video signal, audio signal, application-control signal and synchronization signal of the cooperative application system of this third embodiment of the invention. FIG. 10A is a timing chart for the terminal on the side of the presenter, and FIG. 10B is a timing chart for the terminals other than that of the presenter.

The video signal A shown in FIG. 10A is input from a moving image or still image input from the digital camera or network camera (not shown in the figure) that is connected to the video-input unit 114 of the network terminal B100, which is the terminal on the side of the presenter. The audio signal shown in FIG. 10A is input from the microphone 108 of the network terminal B100. The application-control signal shown in FIG. 10A is a signal for controlling the application in the network terminal B100, and it is output from the application-control unit 102. The synchronization signal A shown in FIG. 10A is a signal that becomes the reference for synchronizing the video signal A, audio signal A and application-control signal A in the network terminal B1000, and it is generated inside the network terminal B100.

The video signal B shown in FIG. 10B is input from moving images or still images from a digital camera or network camera (not shown in the figure) that is connected to the video input unit 214, 314 of network terminal B200, B300 that is a terminal other than that of the presenter. The audio signal B shown in FIG. 10B is input from the microphone 208, 308 of the network terminal B200, B300. The synchronization signal B shown in FIG. 10B is the signal that will be the reference when synchronizing the video signal B and audio signal B in the network terminal B200, B300, and it is generated in the network terminal B200, B300.

First, in the network terminal B100 that operates as the terminal on the side of the presenter, the multiplexed-data-generation unit of the time-control unit 113 synchronizes each of the signals shown in FIG. 10A and generates packet data of the multiplexed data, then sends it outside the terminal by way of the sending unit 103.

The network terminal B200, B300, which is a terminal other than that of the presenter, receives the packet data, and the reproduction-timing-control unit 213B, 313B of the timing-control unit 213, 313 synchronizes and outputs (reproduces) the data. In other words, the network terminal B200, B300 displays the received video signal A on part of the display unit (not shown in the figure), reproduces the audio signal A by the speakers 107, and sends an instruction to the application based on the application control signal. As a result, the application that receives the instruction displays the application data on part of the display unit (not shown in the figure).

On the other hand, in the network terminal B200, B300 that is a terminal other than that of the presenter, the multiplexed-data-generation unit of the time-control unit 213, 313, synchronizes each of the signals shown in FIG. 10B and generates multiplexed packet data, then sends it outside the terminal by way of the sending unit 203, 303. At this time, network terminals B100, B300 (or B200) that are not the network terminal B200 (or B300) on the sending side, receive the packet data, and the reproduction-timing-control unit 113B, 313B (or 213B) of the time-control unit 113, 313 (or 213) synchronizes the data and outputs it. In other words, the network terminals B100, B300 (or B200) display the received video signal B on part of the display unit (not shown in the figure), and reproduce the audio signal B by the speakers 107, 307 (or 207).

In this way, any of the terminals other than that of the presenter can send its own video signal B and audio signal B to another terminal. It is preferred that the terminal on the receiving side be constructed such that it is capable of switching among the video and audio received from each of the terminals. That is, in the case in which a presentation is being given by the presenter, for example, the video that is displayed on the display unit (not shown in the figure) and the audio that is reproduced by the speakers 107, 307 (or 207), and when there is an opinion or question from the side of another terminal that reproduces the signals of the terminal on the side of the presenter, the reproduction-timing-control unit switches to the video and audio of the other terminal.

As explained above, with this third embodiment of the invention, multiplexed data comprising an application-control signal and synchronization signal in addition to the video signal and audio signal are sent and received as packet data between terminals. Therefore, the amount of screen data of an application that is displayed by the terminal on the side of the presenter and that is sent to another terminal can be reduced when compared with the conventional method of sending data, and it is also possible to reduce the processing for receiving packet data by other terminals, so even at terminals other than that of the presenter, it is possible to control the application (switch the presentation documents) while reproducing video and audio at the same timing as the terminal on the side of the presenter. Moreover, in the case where the video is high-definition quality, it is particularly possible to reduce the processing of sending and receiving packet data by the terminals, so a remarkable effect can be seen in the shift of the video and audio.

Also, the reproduction-timing-control unit can switch the video and/or audio according to the input packet, so it is possible to know the condition a other receiving locations in addition to the condition at the side of the presenter.

### Industrial Applicability

The network terminal, cooperative application system, cooperative application method and program of this invention make it possible to share video at various locations without sending the video of the display or the like of the sending side. Therefore, it is useful as a multimedia conference system terminal when a plurality of users at different locations participate in the same conference by way of a normal subscriber telephone line, Internet network, DSL network, private-line network or the like.

What is claimed is:

1. A cooperative application system that links the operation of applications between a sending terminal and a receiving terminal that are connected via a network and comprising on the sending terminal side:
a first application-control unit that is operable to output instructions to the application operating at that sending terminal; and
a sending unit that is operable to send the instructions received from said first application to said receiving terminal; and comprising on the receiving terminal side:
a receiving unit that is operable to receive said instructions from said sending terminal; and
a second application-control unit that is operable to output said received instructions to the application operating at said receiving terminal.

2. The cooperative application system of claim 1 wherein at least said sending terminal or said receiving terminal further comprises an application-data-management unit that is operable to check at least one kind of:
the type of application operating at another terminal;
the status of the application operating at said sending terminal; and
the compatibility of the application data being used by the application of the sending terminal,
with its own terminal.

3. The cooperative application system of claim 1 wherein
said sending unit is operable to send to a specified server, address information of said receiving terminal, contents used by the application operating at said receiving terminal, and a send instruction to send said contents to said receiving terminal; and wherein
said receiving unit is operable to receive said contents from said server and give said contents to the application operating at said receiving terminal.

4. The cooperative application system of claim 1 wherein
said sending unit is operable to send to a specified server the contents that are used by the application operating at said receiving terminal, and send the address information for said server to the receiving unit of said receiving terminal; and wherein
said receiving unit is operable to receive said contents from said server based on the received address information for said server, and give said contents to the application that operates at said receiving terminal.

5. The cooperative application system of claim 1 wherein
said sending terminal further comprises a first time-control unit that is operable to synchronize and send a video signal that is input to a video-input unit, a audio signal that is input to a audio-input unit and instructions that are output from said application-control unit to said sending unit, and wherein
said receiving terminal further comprises a second time-control unit that is operable to receive said synchronized video signal, audio signal and instructions, and then synchronize and output the video, audio and instructions.

6. The cooperative application system of claim 5 wherein
the video signal input from said video-input unit is a high-definition quality video signal.

7. A network terminal that links the operation of applications between itself and another network terminal that is connected via a network, and comprising:
an application-control unit that is operable to output instructions to the application that is operating at the network terminal; and
a sending unit that is operable to send the instructions that were output from said application-control unit to said other network terminals.

8. The network terminal of claim 7 further comprising an application-data-management unit that is operable to check at least one kind of:
the type of application operating at said another network terminal;
the status of the application operating at said sending terminal; and
the compatibility of the application data being used by the application at the sending terminal,
with its own terminal.

9. The network terminal of claim 7 wherein
said application-control unit is operable to further receive instructions from another network terminal, and output said instructions to the application operating at its own network terminal.

10. The network terminal of claim 9 wherein
said application-control unit is operable to switch according to a setting by a user between a remote-control mode that outputs instructions from said another network terminal to the application, and the normal-control mode that outputs instructions to be performed by its own network terminal.

11. The network terminal of claim 8 further comprising a first time-control unit that is operable to synchronize and output to the sending unit a video signal that is input at the video-input unit, a audio signal that is input at a audio-input unit and instructions that are output from said application-control unit.

12. A network terminal that links the operation of applications between itself and another network terminal that is connected via a network, and comprising:
a receiving unit that is operable to receive instructions output from said another network terminal to the application operating at its own network terminal; and
an application-control unit that is operable to output said received instructions to the application operating at its own network terminal.

13. The network terminal of claim 12 wherein
said receiving unit is operable to receive a synchronized video signal, audio signal and instructions, and comprises
a second time-control unit that is operable to synchronize said received video signal, audio signal and instructions and output them to said application-control unit.

14. A cooperative application method that links the operation of applications between a sending terminal and a receiving terminal that are connected via a network, and comprising:
a first application-control step of outputting instructions to the application operating at the sending terminal;
a sending step of sending the instructions that were output in said first application-control step to said receiving terminal;
a receiving step of receiving said instructions from said sending terminal; and
a second application-control step of outputting said received instructions to the application operating at the receiving terminal.

15. The cooperative application method of claim 14 further comprising:
a first time-control step before said sending step of synchronizing and outputting a video signal that was input at a video-input unit, a audio signal that was input at a audio-input unit and said instructions that were output in said application-control step; and
a second time-control step before said application-control step of synchronizing and outputting the video signal, audio signal and instructions that were received in the receiving step.

16. A program executed by a computer that links the operation of applications with another terminal that is connected via a network and comprising:
a first application-control step of outputting instructions to the application operating at said computer; and
a sending step of sending the instructions that were output in said first application-control step to receiving terminal.
